(19) United States
(12) Patent Application Publication
(10) Pub. No.: US 2012/0251176 A1
(43) Pub. Date: Oct. 4, 2012

(54) ROTATING PRINTER PHOTORECEPTORS HAVING FIXED-POSITION FEATURES

(76) Inventors: Timothy John Young, Williamson, NY (US); Donald Steven Hensel, Rochester, NY (US)

(21) Appl. No.: 13/072,809

(22) Filed: Mar. 28, 2011

(51) Int. Cl. G03G 15/00; F16H 1/20

(52) U.S. Cl. 399/167; 74/412 R

(57) ABSTRACT

An electrophotographic printer includes two photoreceptors driven using respective self-centering free ends of respective selectively-engageable output shafts. The output shafts are driven by respective output gears meshed to a common input gear. Respective centering structures on the photoreceptors receive the free ends of the output shafts; those centering structures are at fixed positions.

### FIELD OF THE INVENTION

This invention pertains to the field of electrophotographic printing and more particularly to driving rotatable components in a printer.

### BACKGROUND OF THE INVENTION

Electrophotography is a useful process for printing images on a receiver (or “imaging substrate”), such as a piece or sheet of paper or another planar medium, glass, fabric, metal, or other objects as will be described below. In this process, an electrostatic latent image is formed on a photoreceptor by uniformly charging the photoreceptor and then discharging selected areas of the uniform charge to yield an electrostatic charge pattern corresponding to the desired image (a “latent image”).

After the latent image is formed, charged toner particles are brought into the vicinity of the photoreceptor and are attracted to the latent image to develop the latent image into a visible image. Note that the visible image may not be visible to the naked eye depending on the composition of the toner particles (e.g., clear toner).

After the latent image is developed into a visible image on the photoreceptor, a suitable receiver is brought into juxtaposition with the visible image. A suitable electric field is applied to transfer the toner particles of the visible image to the receiver to form the desired print image on the receiver. The imaging process is typically repeated many times with reusable photoreceptors.

The receiver is then removed from its operative association with the photoreceptor and subjected to heat or pressure to permanently fix (“fuse”) the print image to the receiver. Plural print images, e.g., of separations of different colors, are overlaid on one receiver before fusing to form a multi-color print image on the receiver.

Electrophotographic (EP) printers typically transport the receiver past the photoreceptor to form the print image. The direction of travel of the receiver is referred to as the slow-scan, process, or in-track direction. This is typically the vertical (Y) direction of a portrait-oriented receiver. The direction perpendicular to the slow-scan direction is referred to as the fast-scan, cross-process, or cross-track direction, and is typically the horizontal (X) direction of a portrait-oriented receiver. “Scan” does not imply that any components are moving or scanning across the receiver; the terminology is conventional in the art.

Various rotatable components, such as belts and drums, used in the electrophotographic process are positioned precisely to avoid periodic objectionable nonuniformities in print images, such as streaks (extending in-track) or bands (extending cross-track). For example, drum photoreceptors are spaced precisely with respect to toning rollers and receivers to provide effective transfer of toner as the visible image and the print image are formed. However, the requirement for precise positioning of photoreceptors requires equally precise positioning of the components that drive those photoreceptors. Precisely positioning these components with respect to each other can be very difficult and expensive. The problem is particularly severe when one motor drives multiple photoreceptors.

Various schemes have been proposed to reduce this precise-positioning burden. Kinematic mounts can be used for the photoreceptors and their drive components. However, kinematic mounting is very expensive and requires significant precision machining Alternatively, flexible couplings can be used between photoreceptors and drive elements. Two universal joints can be used back-to-back; however, universal joints can introduce variations in angular velocity, which can result in changes in the in-track scale of the image as the photoreceptor rotates. Oldham couplings can be used in the presence of parallel misalignment, but cannot accommodate rotational misalignment. Moreover, Oldham couplings use a center plate between two end plates, and the center plate can become dislodged if excess end float is present between the photoreceptor and the drive shaft. Constant-velocity joints have multiple moving parts and bearings that can require periodic lubrication. Moreover, none of these can provide reliable power transmission in the presence of parallel misalignment, rotational misalignment, and end float.

The XEROX PHASER 7500 uses another scheme. A photoreceptor is driven by a nominally-coaxial shaft. If the shaft is misaligned with the axis of the photoreceptor, the end of the photoreceptor closest to the shaft is permitted to move to align with the shaft, while the opposite end remains fixed. However, this can result in differences in image quality cross-track, since the photoreceptor spacing is different on one end than the other.

Alternatively, the drive components can be permitted to move to align with the photoreceptor, and then locked into place. However, when one set of drive components is being used to drive multiple photoreceptors, it is unlikely that all the driven photoreceptors will be spaced apart exactly as their respective driveshafts are, unless the drive components are very tightly-toleranced (and therefore expensive and time-consuming to produce).

There is a continuing need, therefore, for a way of driving multiple rotatable members, such as photoreceptors, from a single set of drive components without requiring expensive and time-consuming high-precision fabrication.

### SUMMARY OF THE INVENTION

According to an aspect of the present invention, there is provided an electrophotographic printer, comprising:

a. two rotatable, selectively-engageable photoreceptors having respective power-receiving structures and respective centering structures;

b. an alignment structure for positioning the respective centering structures at respective fixed positions when the photoreceptors are engaged;

b. a driver for providing motive force;

c. an input gear moved by the driver;

d. two output gears meshed with the input gear, each mounted on a respective output shaft having a fixed end, a self-centering free end, and a power-transmission structure mounted on the free end; and

e. a fixture at a fixed position having two first bearings supporting the fixed ends of the respective output shafts and a second bearing supporting the input gear, so that respective selected spacings are defined between the axis of the input gear and the axis of the respective output gear;

f. so that when the free end of each output shaft is brought into engagement with the centering structure of the corresponding photoreceptor at the fixed position thereof, that output shaft rotates about the corresponding first bearing, or bends, to permit the corresponding free end to center in or on the corresponding centering structure and the corresponding power-transmission structure to engage with the corresponding power-receiving structure, whereby when the driver provides motive force, both photoreceptors rotate.

According to another aspect of the present invention, there is provided apparatus for driving two rotatable, selectively-engageable members having respective power-receiving structures and respective centering structures, the apparatus comprising:

a. an alignment structure for positioning the respective centering structures at respective fixed positions when the members are engaged;

b. a driver for providing motive force;

c. an input gear moved by the driver;

d. two output gears meshed with the input gear, each mounted on a respective output shaft having a fixed end, a self-centering free end, and a power-transmission structure mounted on the free end; and

e. a fixture at a fixed position having two first bearings supporting the fixed ends of the respective output shafts and a second bearing supporting the input gear, so that respective selected spacings are defined between the axis of the input gear and the axis of the respective output gear;

f. so that when the free end of each output shaft is brought into engagement with the centering structure of the corresponding rotational member at the fixed position thereof, that output shaft rotates about the corresponding first bearing, or bends, to permit the corresponding free end to center in or on the corresponding centering structure and the corresponding power-transmission structure to engage with the corresponding power-receiving structure, whereby when the driver provides motive force, both rotatable members rotate.

An advantage of apparatus according to various embodiments of this invention is that it drives multiple rotatable members but does not itself require any precise positioning. Unlike systems using Oldham or Lovejoy couplings, systems according to various embodiments of the present invention do not contain any loose or floating parts, so no parts can become dislodged during operation, or during insertion or removal of a rotating member, e.g., for service. This drive system is self-engaging, making it possible for a user or service technician to readily remove and re-install rotatable members. Similarly, it does not require any permanent connection between the rotatable members and the output shafts. Various embodiments maintain the spacing between the axes of the input and output gears within acceptable limits. This is particularly useful for fine-pitch input and output gears. It permits longer output shafts to be used than prior-art systems, providing increased flexibility in how the mechanical components of a device using this apparatus can be arranged.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an elevational cross-section of an electrophotographic reproduction apparatus suitable for use with various embodiments;

FIG. 2A is a plan, and FIG. 2B a front elevation, of components of electrophotographic printer 100 according to various embodiments;

FIG. 3 is a side elevation of electrophotographic printer components when the photoreceptor is disengaged from the corresponding output shaft;

FIG. 4 is a side elevation of electrophotographic printer components when the photoreceptor is engaged with the corresponding output shaft;

FIG. 5 shows an alignment structure and related components according to various embodiments; and

FIGS. 6A and 6B show two examples of free ends centering in centering structures.

The attached drawings are for purposes of illustration and are not necessarily to scale.

### DETAILED DESCRIPTION OF THE INVENTION

The electrophotographic process can be embodied in devices including printers, copiers, scanners, and facsimiles, and analog or digital devices, all of which are referred to herein as “printers.” Various embodiments described herein are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields).

A digital reproduction printing system (“printer”) typically includes a digital front-end processor (DFE), a print engine (also referred to in the art as a “marking engine”) for applying toner to the receiver, and one or more post-printing finishing system(s) (e.g., a UV coating system, a glosser system, or a laminator system). A printer can reproduce pleasing black-and-white or color onto a receiver. A printer can also produce selected patterns of toner on a receiver, which patterns (e.g., surface textures) do not correspond directly to a visible image. The DFE receives input electronic files (such as Postscript command files) composed of images from other input devices (e.g., a scanner, a digital camera). The DFE can include various function processors, e.g., a raster image processor (RIP), image positioning processor, image manipulation processor, color processor, or image storage processor. The DFE rasterizes input electronic files into image bitmaps for the print engine to print. In some embodiments, the DFE permits a human operator to set up parameters such as layout, font, color, paper type, or post-finishing options. The print engine takes the rasterized image bitmap from the DFE and renders the bitmap into a form that can control the printing process from the exposure device to transferring the print image onto the receiver. The finishing system applies features such as protection, glossing, or binding to the prints. The finishing system can be implemented as an integral component of a printer, or as a separate machine through which prints are fed after they are printed.

The printer can also include a color management system which captures the characteristics of the image printing process implemented in the print engine (e.g., the electrophotographic process) to provide known, consistent color reproduction characteristics. The color management system can also provide known color reproduction for different inputs (e.g., digital camera images or film images).

In an embodiment of an electrophotographic modular printing machine useful with various embodiments, e.g., the NEXPRESS 2100 printer manufactured by Eastman Kodak Company of Rochester, N.Y., color-toner print images are made in a plurality of color imaging modules arranged in tandem, and the print images are successively electrostatically transferred to a receiver adhered to a transport web moving through the modules. Colored toners include colorants, e.g., dyes or pigments, which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

Electrophotographic printers having the capability to also deposit clear toner using an additional imaging module are also known. The provision of a clear-toner overcoat to a color print is desirable for providing protection of the print from fingerprints and reducing certain visual artifacts. Clear toner uses particles that are similar to the toner particles of the color development stations but without colored material (e.g., dye or pigment) incorporated into the toner particles. However, a clear-toner overcoat can add cost and reduce color gamut of the print; thus, it is desirable to provide for operator/user selection to determine whether or not a clear-toner overcoat will be applied to the entire print. A uniform layer of clear toner can be provided. A layer that varies inversely according to heights of the toner stacks can also be used to establish level toner stack heights. The respective color toners are deposited one upon the other at respective locations on the receiver and the height of a respective color toner stack is the sum of the toner heights of each respective color. Uniform stack height provides the print with a more even or uniform gloss.

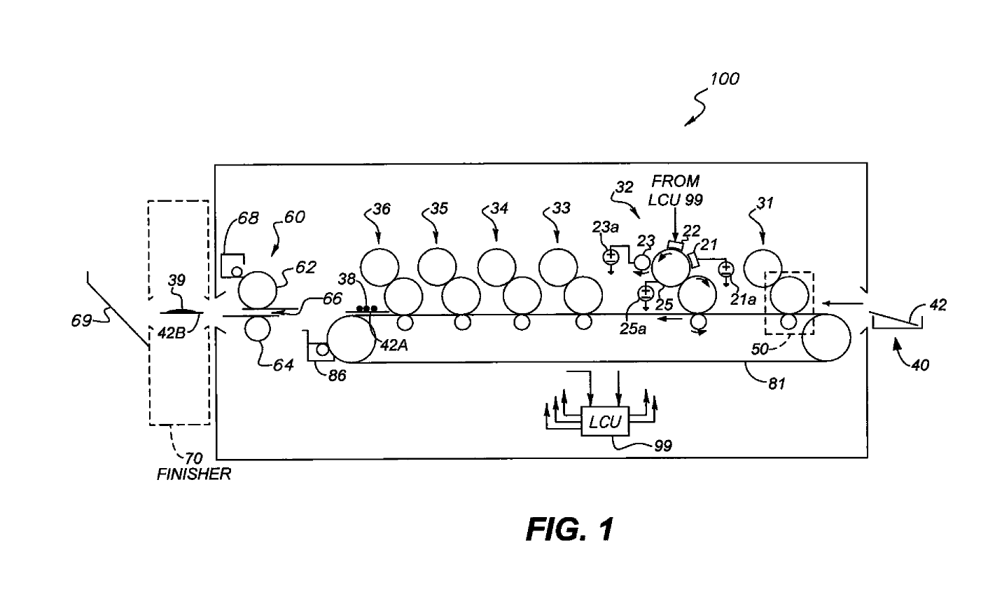

FIG. 1 is an elevational cross-section showing portions of a typical electrophotographic printer 100 useful with various embodiments. Printer 100 is adapted to produce print images, such as single-color (monochrome), CMYK, or hexachrome (six-color) images, on a receiver (multicolor images are also known as “multi-component” images). Images can include text, graphics, photos, and other types of visual content. One embodiment of the invention involves printing using an electrophotographic print engine having six sets of single-color image-producing or -printing stations or modules arranged in tandem, but more or fewer than six colors can be combined to form a print image on a given receiver. Other electrophotographic writers or printer apparatus can also be included. Various components of printer 100 are shown as rollers; other configurations are also possible, including belts.

Referring to FIG. 1, printer 100 is an electrophotographic printing apparatus having a number of tandemly-arranged electrophotographic image-forming printing modules 31, 32, 33, 34, 35, 36, also known as electrophotographic imaging subsystems. Each printing module produces a single-color toner image for transfer using a respective transfer subsystem 50 (for clarity, only one is labeled) to a receiver 42 successively moved through the modules. Receiver 42 is transported from supply unit 40, which can include active feeding subsystems as known in the art, into printer 100. In various embodiments, the visible image can be transferred directly from an imaging roller to a receiver, or from an imaging roller to one or more transfer roller(s) or belt(s) in sequence in transfer subsystem 50, and thence to receiver 42. Receiver 42 is, for example, a selected section of a web of, or a cut sheet of, planar media such as paper or transparency film.

Each printing module 31, 32, 33, 34, 35, 36 includes various components. For clarity, these are only shown in printing module 32. Around photoreceptor 25 are arranged, ordered by the direction of rotation of photoreceptor 25, charger 21, exposure subsystem 22, and toning station 23.

In the EP process, an electrostatic latent image is formed on photoreceptor 25 by uniformly charging photoreceptor 25 and then discharging selected areas of the uniform charge to yield an electrostatic charge pattern corresponding to the desired image (a “latent image”). Charger 21 produces a uniform electrostatic charge on photoreceptor 25 or its surface. Exposure subsystem 22 selectively image-wise discharges photoreceptor 25 to produce a latent image. Exposure subsystem 22 can include a laser and raster optical scanner (ROS), one or more LEDs, or a linear LED array.

After the latent image is formed, charged toner particles are brought into the vicinity of photoreceptor 25 by toning station 23 and are attracted to the latent image to develop the latent image into a visible image. Note that the visible image can be or not be visible to the naked eye depending on the composition of the toner particles (e.g. clear toner). Toning station 23 can also be referred to as a development station. Toner can be applied to either the charged or discharged parts of the latent image.

After the latent image is developed into a visible image on the photoreceptor, a suitable receiver is brought into juxtaposition with the visible image. In transfer subsystem 50, a suitable electric field is applied to transfer the toner particles of the visible image to the receiver to form the desired print image on the receiver. The imaging process is typically repeated many times with reusable photoreceptors.

The receiver 42 is then removed from its operative association with the photoreceptor 25 and subjected to heat or pressure to permanently fix (“fuse”) the print image 38 to the receiver 42. Plural print images, e.g. of separations of different colors, are overlaid on one receiver before fusing to form a multi-color print image on the receiver 42.

Each receiver 42, during a single pass through the six modules, can have transferred in registration thereto up to six single-color toner images to form a pentachrome image. As used herein, the term “hexachrome” implies that in a print image, combinations of various of the six colors are combined to form other colors on the receiver 42 at various locations on the receiver 42. That is, each of the six colors of toner can be combined with toner of one or more of the other colors at a particular location on the receiver 42 to form a color different than the colors of the toners combined at that location. In an embodiment, printing module 31 forms black (K) print images, 32 forms yellow (Y) print images, 33 forms magenta (M) print images, 34 forms cyan (C) print images, 35 forms light-black (Lk) images, and 36 forms clear images.

In various embodiments, printing module 36 forms a print image using a clear toner or tinted toner. Tinted toners absorb less light than they transmit, but do contain pigments or dyes that move the hue of light passing through them towards the hue of the tint. For example, a blue-tinted toner coated on white paper will cause the white paper to appear light blue when viewed under white light, and will cause yellows printed under the blue-tinted toner to appear slightly greenish under white light.

Receiver 42A is shown after passing through printing module 36. Print image 38 on receiver 42A includes unfused toner particles.

Subsequent to transfer of the respective print images, overlaid in registration, one from each of the respective printing modules 31, 32, 33, 34, 35, 36, receiver 42A is advanced to a fuser 60, i.e. a fusing or fixing assembly, to fuse print image 38 to receiver 42A. Transport web 81 transports the print-image-carrying receivers 42 to fuser 60, which fixes the toner particles to the respective receivers by the application of heat and pressure. The receivers 42 are serially de-tacked from transport web 81 to permit them to feed cleanly into fuser 60. Transport web 81 is then reconditioned for reuse at cleaning station 86 by cleaning and neutralizing the charges on the opposed surfaces of the transport web 81. A mechanical cleaning station (not shown) for scraping or vacuuming toner off transport web 81 can also be used independently or with cleaning station 86. The mechanical cleaning station can be disposed along transport web 81 before or after cleaning station 86 in the direction of rotation of transport web 81.

Fuser 60 includes a heated fusing roller 62 and an opposing pressure roller 64 that form a fusing nip 66 therebetween. In an embodiment, fuser 60 also includes a release fluid application substation 68 that applies release fluid, e.g. silicone oil, to fusing roller 62. Alternatively, wax-containing toner can be used without applying release fluid to fusing roller 62. Other embodiments of fusers, both contact and non-contact, can be employed with various embodiments. For example, solvent fixing uses solvents to soften the toner particles so they bond with the receiver. Photoflash fusing uses short bursts of high-frequency electromagnetic radiation (e.g. ultraviolet light) to melt the toner. Radiant fixing uses lower-frequency electromagnetic radiation (e.g. infrared light) to more slowly melt the toner. Microwave fixing uses electromagnetic radiation in the microwave range to heat the receivers (primarily), thereby causing the toner particles to melt by heat conduction, so that the toner is fixed to the receiver.

The receivers (e.g. receiver 42B) carrying the fused image (e.g., fused image 39) are transported in a series from the fuser 60 along a path either to a remote output tray 69, or back to printing modules 31, 32, 33, 34, 35, 36 to create an image on the backside of the receiver, i.e. to form a duplex print. Receivers can also be transported to any suitable output accessory. For example, an auxiliary fuser or glossing assembly can provide a clear-toner overcoat. Printer 100 can also include multiple fusers 60 to support applications such as overprinting, as known in the art.

In various embodiments, between fuser 60 and output tray 69, receiver 42B passes through finisher 70. Finisher 70 performs various media-handling operations, such as folding, stapling, saddle-stitching, collating, and binding.

Printer 100 includes main printer apparatus logic and control unit (LCU) 99, which receives input signals from the various sensors associated with printer 100 and sends control signals to the components of printer 100. LCU 99 can include a microprocessor incorporating suitable look-up tables and control software executable by the LCU 99. It can also include a field-programmable gate array (FPGA), programmable logic device (PLD), microcontroller, or other digital control system. LCU 99 can include memory for storing control software and data. Sensors associated with the fusing assembly provide appropriate signals to the LCU 99. In response to the sensors, the LCU 99 issues command and control signals that adjust the heat or pressure within fusing nip 66 and other operating parameters of fuser 60 for receivers. This permits printer 100 to print on receivers of various thicknesses and surface finishes, such as glossy or matte.

Image data for writing by printer 100 can be processed by a raster image processor (RIP; not shown), which can include a color separation screen generator or generators. The output of the RIP can be stored in frame or line buffers for transmission of the color separation print data to each of respective LED writers, e.g. for black (K), yellow (Y), magenta (M), cyan (C), and red (R), respectively. The RIP or color separation screen generator can be a part of printer 100 or remote therefrom. Image data processed by the RIP can be obtained from a color document scanner or a digital camera or produced by a computer or from a memory or network which typically includes image data representing a continuous image that needs to be reprocessed into halftone image data in order to be adequately represented by the printer 100. The RIP can perform image processing processes, e.g. color correction, in order to obtain the desired color print. Color image data is separated into the respective colors and converted by the RIP to halftone dot image data in the respective color using matrices, which comprise desired screen angles (measured counterclockwise from rightward, the +X direction) and screen rulings. The RIP can be a suitably-programmed computer or logic device and is adapted to employ stored or computed matrices and templates for processing separated color image data into rendered image data in the form of halftone information suitable for printing. These matrices can include a screen pattern memory (SPM).

Various parameters of the components of a printing module (e.g., printing module 31) can be selected to control the operation of printer 100. In an embodiment, charger 21 is a corona charger including a grid between the corona wires (not shown) and photoreceptor 25. Voltage source 21 a applies a voltage to the grid to control charging of photoreceptor 25. In an embodiment, a voltage bias is applied to toning station 23 by voltage source 23a to control the electric field, and thus the rate of toner transfer, from toning station 23 to photoreceptor 25. In an embodiment, a voltage is applied to a conductive base layer of photoreceptor 25 by voltage source 25a before development, that is, before toner is applied to photoreceptor 25 by toning station 23. The applied voltage can be zero; the base layer can be grounded. This also provides control over the rate of toner deposition during development. In an embodiment, the exposure applied by exposure subsystem 22 to photoreceptor 25 is controlled by LCU 99 to produce a latent image corresponding to the desired print image. All of these parameters can be changed, as described below.

Further details regarding printer 100 are provided in U.S. Pat. No. 6,608,641, issued on Aug. 19, 2003, to Peter S. Alexandrovich et al., and in U.S. Publication No. 2006/0133870, published on Jun. 22, 2006, by Yee S. Ng et al., the disclosures of which are incorporated herein by reference.

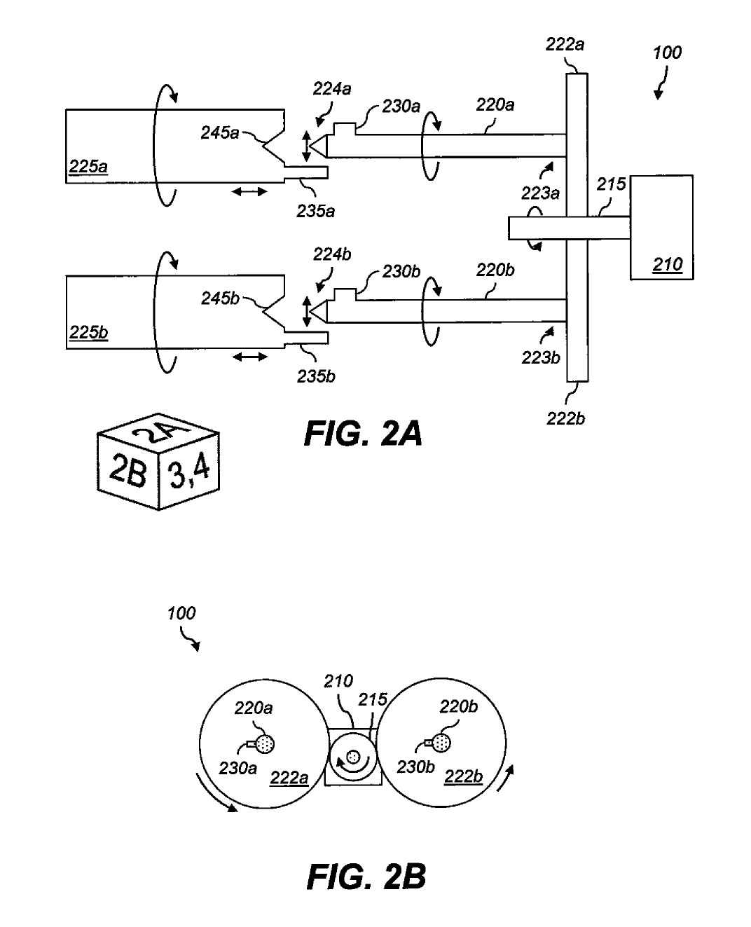

FIG. 2A is a plan, and FIG. 2B a front elevation, of components of electrophotographic printer 100 according to various embodiments. The 3-D box shows the perspective relationships between FIGS. 2A, 2B, 3, and 4. However, these figures do not all show identical embodiments.

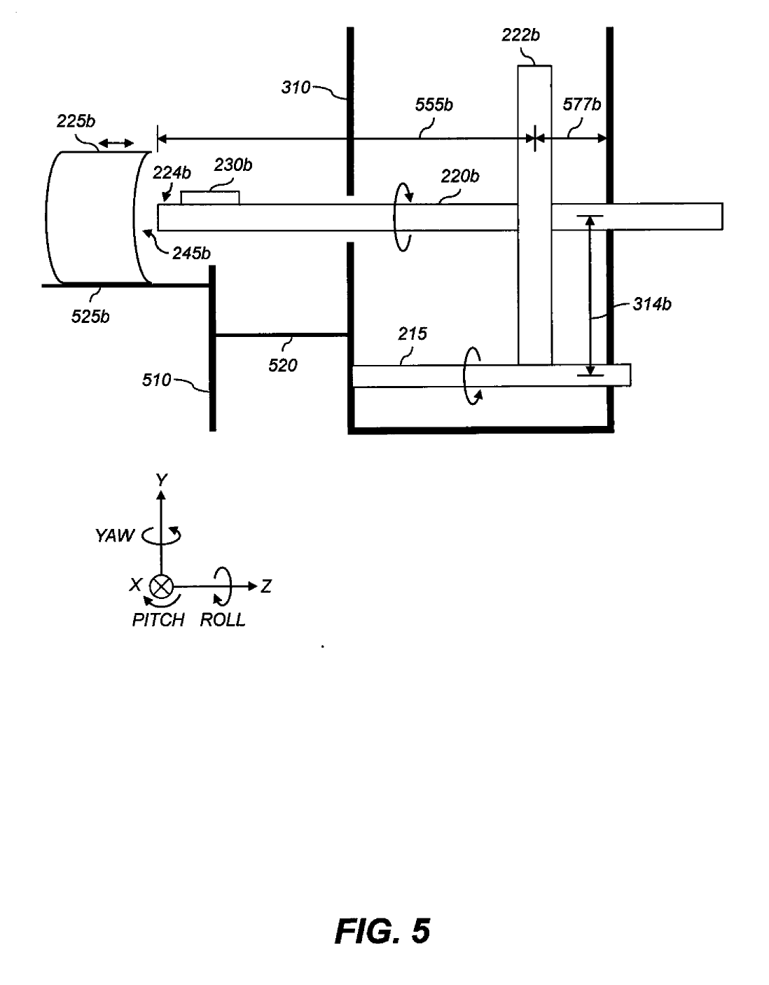

Printer 100 includes two rotatable, selectively-engageable photoreceptors 225a, 225b as discussed above with respect to photoreceptor 25 (FIG. 1). Each photoreceptor 225a, 225b has a respective power-receiving structure 235a, 235b and a respective centering structure 245a, 245b at a respective fixed position, as discussed below with reference to FIG. 5.

Centering structure 245a, 245b can be an indentation, a pin, an indentation with a pin in its center, or a raised or lowered ring. Centering structure 245a, 245b can be any self-centering mechanical structure that will force each output shaft 220a, 220b into itself while the corresponding photoreceptor 225a, 225b is inserted into the printer.

Driver 210, e.g., a motor, provides motive force to rotate the photoreceptors 225a, 225b.

Input gear 215, e.g., a rack or a circular gear, is moved by driver 210. Other power-transmission parts, e.g., one or more shafts or belts, can be present between driver 210 and input gear 215.

Output gears 222a, 222b are meshed with input gear 215. Other power-transmission parts, e.g., one or more shafts or belts, can be present between input gear 215 and each output gear 222a, 222b.

Each output gear 222a, 222b is mounted on a respective output shaft 220a, 220b. Each output shaft has a fixed end 223a, 223b and a self-centering free end 224a, 224b. Power-transmission structures 230a, 230b are mounted on respective free ends 224a, 224b. That is, each power-transmission structure 230a, 230b is attached to the respective output shaft 220a, 220b sufficiently close to free end 224a, 224b to engage with the corresponding power-receiving structure 235a, 235b on the corresponding photoreceptor 225a, 225b.

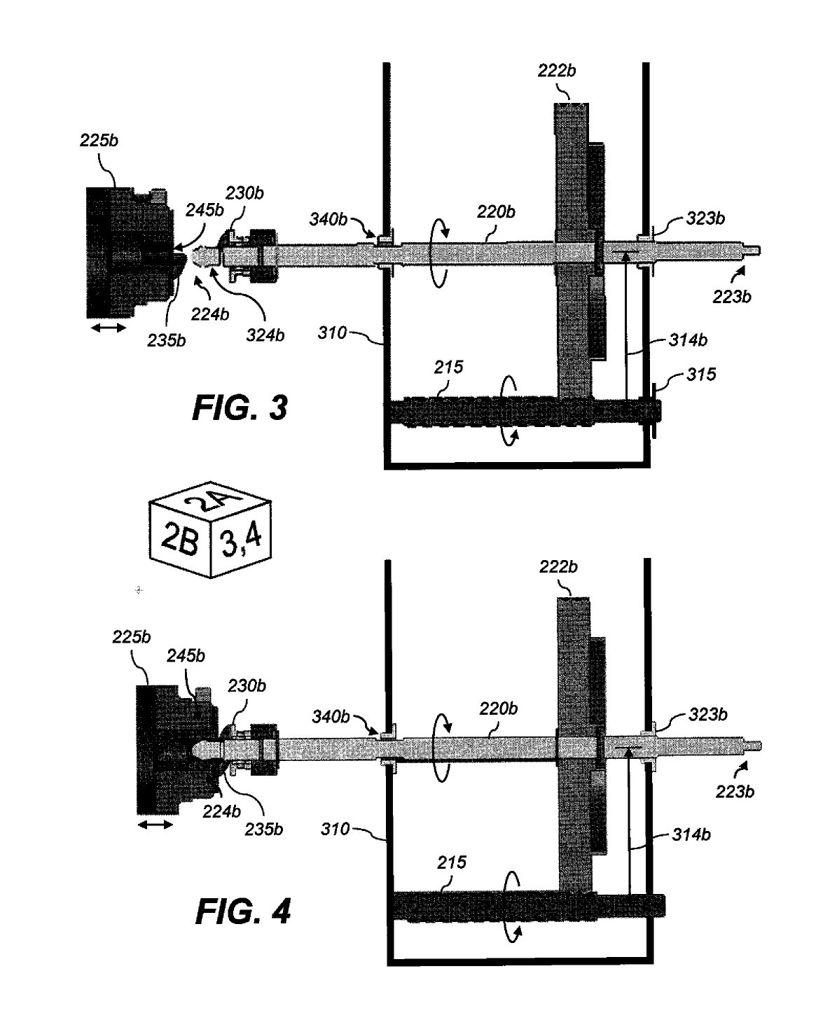

Photoreceptors 225a, 225b are selectively engageable with respective output shafts 220a, 220b, either individually or together. To engage, free end 224a, 224b of each output shaft 220a, 220b is brought into engagement when centering structure 245a, 245b of corresponding photoreceptor 225a, 225b is at the fixed position of the photoreceptor 225a, 225b. When engaging, the appropriate output shaft 220a, 220b rotates about a first bearing (discussed below with reference to FIGS. 3 and 4), or bends, or both. This motion permits the corresponding free end 224a, 224b to center in or on the corresponding centering structure 245a, 245b and the corresponding power-transmission structure 230a, 230b to engage with the corresponding power-receiving structure 235a, 235b. When the photoreceptors 225a, 225b and output shafts 220a, 220b are engaged and driver 210 provides motive force, both photoreceptors 225a, 225b rotate.

By “center” it is meant that free end 224a (and, respectively, free end 224b) engaged in centering structure 245a is engaged in such a way as to transmit power. Angular or positional misalignment between photoreceptor 225a and corresponding free end 224a can be present when photoreceptor 225a engages corresponding free end 224a. In various examples, ±2° or ±5° of angular misalignment, and any corresponding positional deviation between the centers of free end 224a and the center of centering structure 245a due to their respective shapes, or ±1 mm of positional misalignment, are within tolerances for “centered”. In an embodiment, positional misalignment is held to tighter tolerances than angular misalignment. As the ratio described below with respect to FIG. 5 increases, more misalignment can be tolerated without impairing the transmission of power. This will be discussed further below.

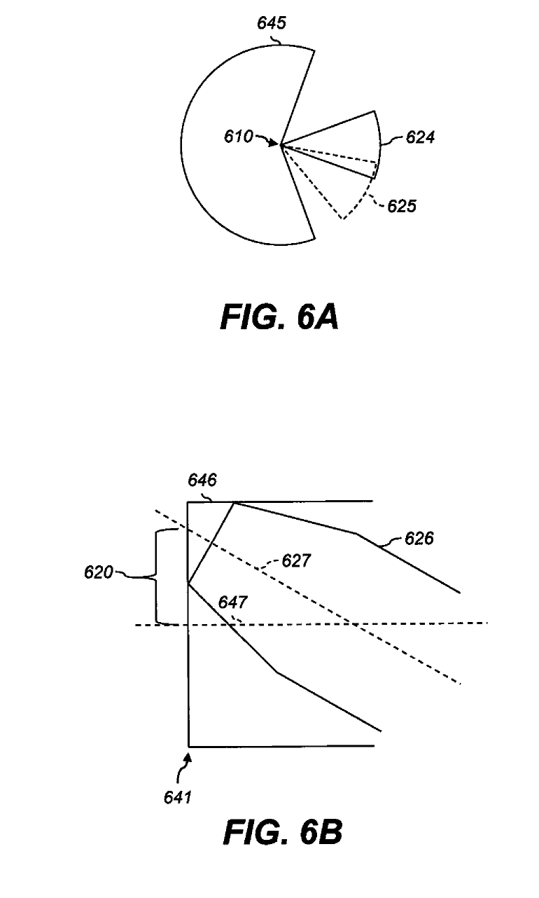

FIG. 6A shows an example of free end 624 centered in centering structure 645, and in contact therewith at point 610. Since free end 624 subtends a small angle, it can rotate by a significant amount and still maintain contact at point 610, for example as shown by free end 625.

FIG. 6B shows an example of free end 626 centered in centering structure 646 in the presence of misalignment between the photoreceptor 225a (not shown), 225b and the output shaft 220a (not shown), 220b. For clarity, the misalignment is exaggerated in this figure. Centerline 627 of free end 626 does not coincide with centerline 647 of centering structure 646 at back wall 641 of centering structure 646. There is a distance 620 between them along back wall 641. This is acceptable, and free end 626 is still considered to be “centered” in centering structure 646, since the engagement still permits power to be transferred.

Referring back to FIGS. 2A-2B, in various embodiments, power-transmission structures 230a, 230b and power-receiving structures 235a, 235b include protrusions that interface when photoreceptors 225a, 225b are engaged with corresponding output shafts 220a, 220b. In various embodiments, each power-transmission structure 230a, 230b includes a respective flat surface facing in the direction of rotation of output shafts 220a, 220b for transmitting power. Each power-receiving structure 235a, 235b includes a respective flat surface facing opposite the direction of rotation of output shafts 220a, 220b for receiving power by being driven by the flat surfaces of power-transmission structures 230a, 230b. The power-transmission 230a, 230b and -receiving structures 235a, 235b can also include curved surfaces opposite the flat surfaces to produce an angular force to rotate the photoreceptors 225a, 225b or output shafts 220a, 220b while photoreceptors 225a, 225b are engaged with output shafts 220a, 220b. This permits photoreceptors to be inserted without concern for potential interferences between the power-transmission 230a, 230b and -receiving structures 235a, 235b, since the photoreceptor or output shaft will rotate on the curved surfaces of the protrusions if the protrusions interfere. This rotation will relieve the interference.

FIG. 3 is a side elevation of electrophotographic printer components when the photoreceptor is disengaged from the corresponding output shaft. Photoreceptor 225b with centering structure 245b and power-receiving structure 235b, output shaft 220b with fixed end 223b, free end 224b, and power-transmission structure 230b, input gear 215, and output gear 222b are as shown in FIGS. 2A and 2B.

Input gear 215 and output gear 222b are mounted in fixture 310. Fixture 310 can be a housing or plate and is not required to completely enclose any volume. Fixture 310 includes two first bearings 323a (not shown), 323b supporting the fixed ends 223a (not shown), 223b of the respective output shafts 220a (not shown), 220b. Output shaft 220a (not shown) is supported with first bearing 323a (not shown) in the same way that output shaft 220b is supported with first bearing 323b. Fixture 310 also includes a second bearing 315 supporting the input gear 215. Respective selected spacings 314a (not shown), 314b are thus defined between the axis of input gear 215 and the respective axis of each output shaft 220a (not shown), 220b. In various embodiments, first bearings 323a (not shown), 323b permit ±5% rotation in pitch or yaw. Aperture 340 is discussed below.

In various embodiments, free ends 224a (not shown), 224b of output shafts 220a (not shown), 220b include relief 324a (not shown), 324b. Relief 324b reduces the probability of interference between free ends 224a (not shown), 224b and centering structures 245a (not shown), 245b. Since output shafts 220a (not shown), 220b will in general not be coaxial with photoreceptors 225a (not shown), 225b, free ends 224a (not shown), 224b will enter centering structures 245a (not shown), 245b at an angle. The edges or perimeters of centering structures 245a, 245b will therefore protrude into relief 324a (not shown), 324b.

In FIG. 3, photoreceptor 225b and output shaft 220b are shown disengaged. Photoreceptor 225b can be disengaged and removed from printer 100 for cleaning, maintenance, or replacement. Photoreceptor 225b can then be re-engaged with output shaft 220b for operation.

FIG. 4 is a side elevation of electrophotographic printer components when photoreceptor 225b is engaged with corresponding output shaft 220b. Photoreceptor 225b with centering structure 245b and power-receiving structure 235b, output shaft 220b with fixed end 223b, free end 224b, and power-transmission structure 230b, input gear 215, and output gear 222b are as shown in FIGS. 2A and 2B. Photoreceptor 225a (FIG. 2A) and related components correspond to those shown here. Free end 224b has engaged with centering structure 245b even if some rotational or translational offset is present between the rotational axis of photoreceptor 225b and the rotational axis of output shaft 220b. As described above with reference to FIGS. 6A-6B, free end 224b centers in centering structure 245b to transmit power even in the presence of misalignment. Power-transmission structure 230b is engaged with power-receiving structure 235b so that rotation of output shaft 220b imparts rotation of photoreceptor 225b.

As discussed above, the motion of output shaft 220b permits the corresponding free end 224a (not shown), 224b to center in or on the corresponding centering structure 245a (not shown), 245b. When engaging, output shaft 220b can bend. Output shaft 220b can also rotate about first bearing 323a (not shown) on an axis of rotation different from the axis of rotation of shaft 220b when driven. That is, considering the normal operation of output shaft 220b when driven as a roll motion, output shaft 220b can experience pitch or yaw centered on first bearing 323a. Output shaft 220b can also roll to relieve interferences between power-transmission structure 230b and power-receiving structure 235b.

In various embodiments, fixture 310 further includes two apertures 340a (not shown), 340b through which free ends 224a (not shown), 224b of respective output shafts 220a (not shown), 220b protrude. Apertures 340a (not shown), 340b provide enough space for output shafts 220a (not shown), 220b to bend or rotate to align with centering structures 245a (not shown), 245b. In some embodiments, respective washers are provided in apertures 340a, 340b to reduce the risk of scoring output shafts 220a, 220b in case of overload or transient deflection or deformation out to the edge of apertures 340a, 340b. Washers can also support output shafts 220a, 220b if the shafts sag under their own weight when photoreceptors 225a (not shown), 225b are removed.

When either output shaft 220a, 220b rotates (in pitch or yaw) or bends, the spacing between the axis of the input gear 215 and the axis of the respective output gear 220a, 220b changes. In various embodiments, the resulting spacing is within five percent, or within one percent, of selected spacing 314b. These tolerances advantageously maintain the teeth of input gear 215 and output gears 222a (not shown), 222b in mesh so that rotational power is transferred effectively. As will be discussed below, finer-pitch teeth are preferred.

FIG. 5 shows an alignment structure and related components according to various embodiments. Input gear 215, output gear 222b, output shaft 220b, fixture 310, power-transmission structure 230b, photoreceptor 225b, and centering structure 245b are as shown in FIG. 3. As in FIGS. 3 and 4, corresponding parts are present for photoreceptor 225a (FIG. 2A), although they are not shown in this view. In this view, the +X coordinate is into the page, +Y is towards the top of the page, and +Z is toward the right edge of the page. The coordinate system is right-handed. Positive roll is clockwise when looking in the +Z direction (right-hand rule), positive pitch is clockwise looking in the +X direction, and positive yaw is clockwise looking in the +Y direction.

In various embodiments, fixture 310 is at a fixed position, i.e., fixed within mounting and clearance tolerances that permit power to be transmitted effectively between output shaft 220b and photoreceptor 225b. That is, as photoreceptor 225b is engaged and disengaged, fixture 310 maintains a true position within a selected tolerance, e.g., ±0.5mm. That is, a locator pin affixed to fixture 310 passes through a hole of radius 0.5 mm on alignment structure 510. The tolerances for any particular embodiment are determined by separating the total misalignment budget into permissible tolerances for free end 224b with respect to centering structure 245b, and permissible tolerances for fixture 310 with respect to alignment structure 510. Output shaft 220b bends or rotate to accommodate misalignment, but its mounting hardware (e.g., first bearing 323b, FIG. 4) remains fixed in position. This advantageously reduces cross-coupling of misalignment-induced effects from one photoreceptor to another.

In various embodiments, photoreceptor 225b engages and disengages by sliding on rails 525b. In other embodiments, photoreceptor 225b is included in a cartridge or other removable mechanical fixture, and the cartridge slides on rails 525b. Rails 525b are connected to alignment structure 510.

Alignment structure 510 is a plate or other mechanical fixture. Alignment structure 510 positions respective centering structures 245a (not shown), 245b at respective fixed positions, i.e., fixed within mounting and clearance tolerances, when photoreceptors 225a (not shown), 225b are engaged.

“Fixed position” refers to the time the photoreceptor 225a, 225b is engaged in the printer and does not mean the photoreceptors 225a, 225b cannot be disengaged. As shown, photoreceptor 225b can be moved in the Z direction to engage it or disengage it from the printer. Photoreceptor 225b can also move in the other five degrees of freedom while engaging, e.g., by rotating into a lock-up position. Once photoreceptor 225b is engaged in the printer, its centering structure 245b has a fixed position.

In an example, “fixed position” is a true position of centering structure 245b within ±0.01 mm, or ±0.1 mm. That is, while engaging output shaft 220b, a selected reference point on centering structure 245b (and thus photoreceptor 225b) remains within a circle of radius ±0.01 mm, or ±0.1 mm. As a result, if misalignment greater than twice that radius is present, free end 224b translates more than centering structure 245b in the X and Y directions while the two engage. In some embodiments, alignment structure 510 is mechanically connected to fixture 310 by pin 520. In other embodiments, alignment structure 510 is part of fixture 310, or vice-versa.

In various embodiments, rails 525b and fixture 310 mount to alignment structure 510. Alignment structure 510 therefore provides coarse alignment between the drive structure mounted on fixture 310 and photoreceptor 225b riding on rails 525b. That output shaft 220b is self-centering advantageously permits fabricating alignment structure 510 and fixture 310 with looser tolerances than would otherwise be required. Using alignment structure 510 and rails 525b, or other mechanical fixtures that support both ends of photoreceptor 225b, advantageously reduces unintentional variations or errors in the position of photoreceptor 225b with respect to receiver 42 (FIG. 1) or other components of the printer 100. In various embodiments, locator pins attached to alignment structure 510 can engage recesses on photoreceptor 225b to align the latter to the former.

Various embodiments provide particular advantages in imaging systems. Any rotatable member in a printer can produce noise in a printed image on a receiver at the spatial frequency corresponding to the rotational frequency of the member and the speed of transport of the receiver through the printer. For example, if a particle becomes lodged at the base of a gear tooth, it can cause a spacing variation by pushing the mating gear away once per revolution. This is analogous to the once-per-revolution click of a pebble stuck in a car tire. If the member had a rotational frequency of 2 Hz and was being used to produce one print per second (60 ppm), the particle would cause an artifact twice per print. In another example, the meshing and unmeshing of the gear teeth can cause an artifact if the force varies as each successive tooth pair meshes and unmeshes. If the 2 Hz member had 30 teeth that did not mesh smoothly, 60 artifacts would be visible on the print. As a result, finer-pitch gear teeth are preferred, since the human visual system's sensitivity to spatial variation drops off above a certain peak-sensitivity frequency, e.g., above about 3 cycles per degree. Finer-pitch teeth provide higher frequency noise that is more likely to be invisible. Pitch can be measured using diametral pitch, the number teeth per unit length of the diameter of the pitch circle approximately half-way up the gear teeth. Diametrial pitch is described further in, e.g., Patton, W. J. Mechanical Power Transmission. Prentice Hall, 1980. ISBN 0-13-569905-3. Contrast sensitivity of the human visual system is described further in, e.g., Sukumar et al., Study on threshold patterns with varying illumination using 1.3 m imaging system. 2 INTELLIGENT INFORMATION MANAGEMENT 21, 22 (Jan. 2010), Digital Object Identifier (DOI) 10.4236/iim.2010.21003.

However, since the teeth of spur gears follow involute-curve profiles, higher diametral pitch requires shorter teeth (less distance between the base circle and the outer circle of a gear). As a result, tighter tolerances are required on spacing 314b. In various embodiments, spacing 555b (S_{555b}) is substantially greater than spacing 577b (S_{577b}). The displacement of output gear 222b with respect to input gear 215 when photoreceptor 225b engages, denoted Δ_{314b}, is less than the displacement of free end 224b (Δ_{224b}). Specifically,

Δ_{314b}[S_{577b}/(S_{555b}+S_{577b})]×Δ_{224b}.

Letting R=S_{555b}/S_{577b}, in various embodiments, R>5, or R>10, or R>25. Higher ratios R provide more tolerance for misalignment while maintaining spacing 314b within tolerance. This advantageously provides mechanical flexibility and reduces machining cost without negatively affecting performance. As discussed above with reference to FIGS. 2A, 2B, and 6, bending or rotation of output shaft 220b can result in positional misalignment between the center of free end 224b and the center of centering structure 245b. As R increases, the positional difference between the two ends of output shaft 220b resulting from a given bend or rotation thereof decreases. This can provide reduced misalignment with centering structure 245b.

Specifically, in various embodiments, the ratio of the spacing 555b between the free end 224b of each output shaft 220b and the corresponding output gear 222b to the spacing 577b between the corresponding output gear 222b and the corresponding fixed bearing 323b (FIGS. 3 & 4) is greater than five. In various embodiments, this ratio characterizes some or all output shafts (e.g., output shafts 220a, 220b). It is not required that all output shafts or photoreceptors be the same length in the Z direction.

In various embodiments, helical gears are used for input gear 215 or output gears 222a (not shown), 222b. The helix angle of the teeth of each gear is selected to impart axial (thrust) force on each output gear 215 in the direction of respective first bearing 323a (not shown), 323b (FIG. 3). This reduces floating of the shaft and maintains output-shaft axial position with respect to the photoreceptor.

The structures shown in FIGS. 2A-4 can be used to drive other rotatable members. Instead of photoreceptors 225a, 225b (FIG. 2A), any two rotatable, selectively-engageable members can be driven. The rotatable members have respective power-receiving structures 235a, 235b and respective centering structures 245a, 245b, as described above. An alignment structure positions the respective centering structures 245a, 245b at respective fixed positions when the members are engaged, also as described above. A driver provides motive force through an input gear 215 and two output gears 222a, 222b meshed with the input gear 215 to the output shafts 220a, 220b on which the output gears 222a, 222b are mounted. Each output shaft 220a, 220b has a fixed end, a self-centering free end 224a, 224b, and a power-transmission structure 230a, 230b mounted on the free end 224a, 224b, as described above. A fixture at a fixed position has two first bearings 323a (not shown), 323b supporting the fixed ends 223a, 223b of the respective output shafts 220a, 220b and a second bearing supporting the input gear 215, so that respective selected spacings 314b are defined between the axis of the input gear 215 and the axis of the respective output gear 222a, 222b, as described above. As a result, when the free end 224a, 224b of each output shaft 220a, 220b is brought into engagement when the centering structure 245a, 245b of the corresponding rotational member at the fixed position thereof, that output shaft 220a, 220b rotates about the corresponding first bearing 323a (not shown) or 323b, or bends, or both, to permit the corresponding free end 224a, 224b to center in or on the corresponding centering structure 245a, 245b and the corresponding power-transmission structure 230a, 230b to engage with the corresponding power-receiving structure 235a, 235b. As a result, when the driver provides motive force, both rotatable members rotate, as described above.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

21 charger
21a, 23a, 25a voltage source
22 exposure subsystem
23 toning station
25 photoreceptor
31, 32, 33, 34, 35, 36 printing module
38 print image
39 fused image
40 supply unit
42, 42A, 42B receiver
50 transfer subsystem
60 fuser
62 fusing roller
64 pressure roller
66 fusing nip
68 release fluid application substation
69 output tray
70 finisher
81 transport web
86 cleaning station
99 logic and control unit (LCU)
100 printer
210 driver
215 input gear
220a, 220b output shaft
222a, 222b output gear
223a, 223b fixed end
224a, 224b free end
225a, 225b photoreceptor
230a, 230b power-transmission structure
235a, 235b power-receiving structure
245a, 245b centering structure
310 fixture
314b spacing
315 second bearing
323b first bearing
324b relief
340b aperture
510 alignment structure
520 pin
525b rails
555b, 577b spacing
610 point
620 distance
624 free end
625 free end
626 free end
627 center line
641 back wall
645 centering structure
646 centering structure

1. An electrophotographic printer, comprising:
a. two rotatable, selectively-engageable photoreceptors having respective power-receiving structures and respective centering structures;
b. an alignment structure for positioning the respective centering structures at respective fixed positions when the photoreceptors are engaged;
b. a driver for providing motive force;
c. an input gear moved by the driver;
d. two output gears meshed with the input gear, each mounted on a respective output shaft having a fixed end, a self-centering free end, and a power-transmission structure mounted on the free end; and
e. a fixture at a fixed position having two first bearings supporting the fixed ends of the respective output shafts and a second bearing supporting the input gear, so that respective selected spacings are defined between the axis of the input gear and the axis of the respective output gear;
f. so that when the free end of each output shaft is brought into engagement with the centering structure of the corresponding photoreceptor at the fixed position thereof, that output shaft rotates about the corresponding first bearing, or bends, to permit the corresponding free end to center in or on the corresponding centering structure and the corresponding power-transmission structure to engage with the corresponding power-receiving structure, whereby when the driver provides motive force, both photoreceptors rotate.

2. The apparatus according to claim 1, wherein when either output shaft rotates or bends, the spacing between the axis of the input gear and the axis of the respective output gear changes, and the resulting spacing is within five percent of the selected spacing.

3. The apparatus according to claim 1, wherein the fixture further includes two apertures through which the free ends of the respective output shafts protrude.

4. The apparatus according to claim 1, wherein the ratio of the spacing between the free end of each output shaft and the corresponding output gear to the spacing between the corresponding output gear and the corresponding fixed bearing is greater than five.

5. The apparatus according to claim 1, wherein the input gear and the output gears are helical gears, and the helix angle of each gear is selected to impart axial force on each output gear towards the respective first bearing.

6. Apparatus for driving two rotatable, selectively-engageable members having respective power-receiving structures and respective centering structures, the apparatus comprising:
a. an alignment structure for positioning the respective centering structures at respective fixed positions when the members are engaged;
b. a driver for providing motive force;
c. an input gear moved by the driver;
d. two output gears meshed with the input gear, each mounted on a respective output shaft having a fixed end, a self-centering free end, and a power-transmission structure mounted on the free end; and
e. a fixture at a fixed position having two first bearings supporting the fixed ends of the respective output shafts and a second bearing supporting the input gear, so that respective selected spacings are defined between the axis of the input gear and the axis of the respective output gear;
f. so that when the free end of each output shaft is brought into engagement with the centering structure of the corresponding rotational member at the fixed position thereof, that output shaft rotates about the corresponding first bearing, or bends, to permit the corresponding free end to center in or on the corresponding centering structure and the corresponding power-transmission structure to engage with the corresponding power-receiving structure, whereby when the driver provides motive force, both rotatable members rotate.

7. The apparatus according to claim 6, wherein when either output shaft rotates or bends, the spacing between the axis of the input gear and the axis of the respective output gear changes, and the resulting spacing is within five percent of the selected spacing.

8. The apparatus according to claim 6, wherein the fixture further includes two apertures through which the free ends of the respective output shafts protrude.

9. The apparatus according to claim 6, wherein the ratio of the spacing between the free end of each output shaft and the corresponding output gear to the spacing between the corresponding output gear and the corresponding fixed bearing is greater than five.

10. The apparatus according to claim 6, wherein the input gear and the output gears are helical gears, and the helix angle of each gear is selected to impart axial force on each output gear towards the respective first bearing.

11. The apparatus according to claim 6, wherein the rotatable members are photoreceptors.
